(19) United States
(12) Patent Application Publication
(10) Pub. No.: US 2005/0052275 A1
(43) Pub. Date: Mar. 10, 2005

(54) Method of controlling movement on the inside and around the outside of a facility

(76) Inventor: Vernon George Houle, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/727,284

(22) Filed: Dec. 3, 2003

(30) Foreign Application Priority Data
Sep. 4, 2003 (CA) 2,439,722

(51) Int. Cl. H04Q 1/00; G05B 19/00

(52) U.S. Cl. 340/5.61; 340/5.7; 340/5.3

(57) ABSTRACT

A method of controlling movement on the inside and around the outside of a facility, which includes providing each person within the facility with a transmitter which emits a unique personality profile, embedded in the unique personality profile is an access level for that person selected from multiple access levels. Another step involves providing each security door with a lock, a receiver and a controller. The receiver receives the unique personality profile from the transmitter. The controller reviews the access level and unlocks the lock to the security door to permit access only when the unique personality profile has an appropriate access level.

### FIELD OF THE INVENTION

The present invention relates to a method of controlling on the inside and around the outside of a facility, such as an extended health care facility or a prison.

### BACKGROUND OF THE INVENTION

Extended health care facilities currently control movement on the inside and around the outside of the facility by having a series of locking doors. Authorized personnel can freely move through the doors by inputting security codes on key pads to release the locks. In facilities with a large number of doors, the continual inputting of security codes can become burdensome. Personnel tend to bypass the system by jamming doors open for short periods of time. This might occur due to a janitor wanting to take several loads of cleaning supplies into an area past one or more doors or staff wanting to take a group of patients in wheel chairs one at a time from one area of the facility to another. This results in false alarms. Eventually alarm conditions are no longer taken seriously.

### SUMMARY OF THE INVENTION

What is required is a new approach to controlling movement on the inside and around the outside of a facility.

According to the present invention there is provided a method of controlling movement on the inside and around the outside of a facility, which includes providing each person within the facility with a transmitter which emits a unique personality profile, embedded in the unique personality profile is an access level for that person selected from multiple access levels. A further step involves providing each security door with a lock, a receiver and a controller. The receiver receives the unique personality profile from the transmitter. The controller reviews the access level and unlocks the lock to the security door to permit access only when the unique personality profile has an appropriate access level.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a top plan view of a facility employing a method of controlling movement on the inside and around the outside of the facility in accordance with the teachings of the invention.

FIG. 2 is a perspective view of a band person with a tamper-resistant band

FIG. 3 is a side elevation view of a security door.

### DETAILED DESCRIPTION OF THE PREFERRED EMBODIMENT

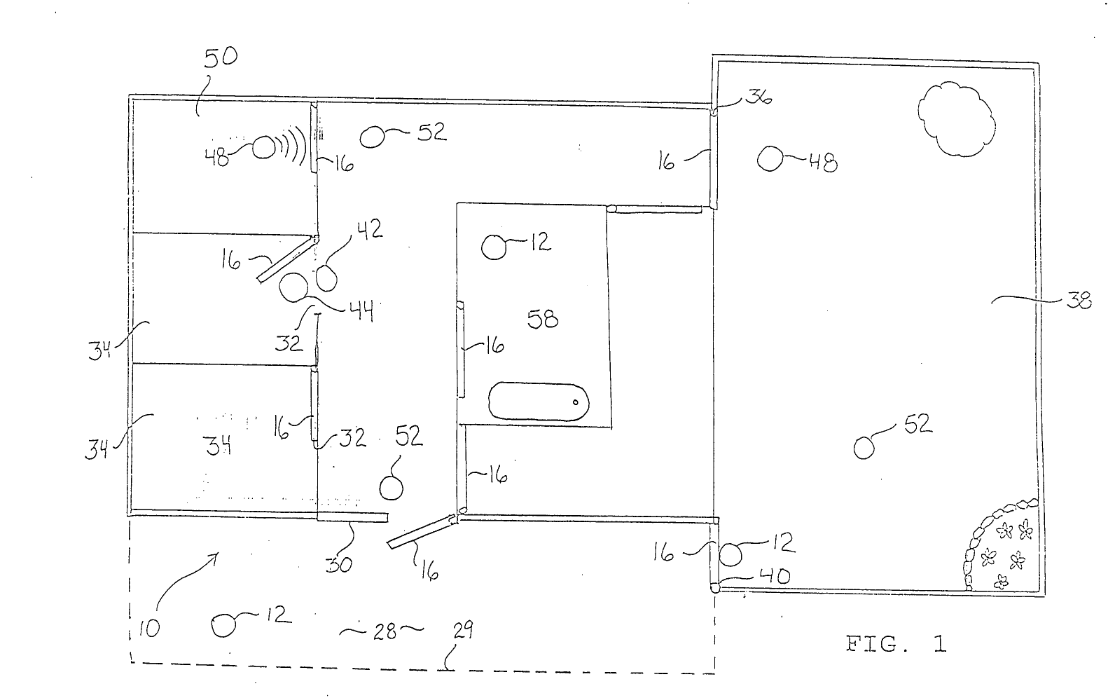

The preferred embodiment, a method illustrated a method of controlling movement on the inside and around the outside of a facility will now be described with reference to FIGS. 1 through 3.

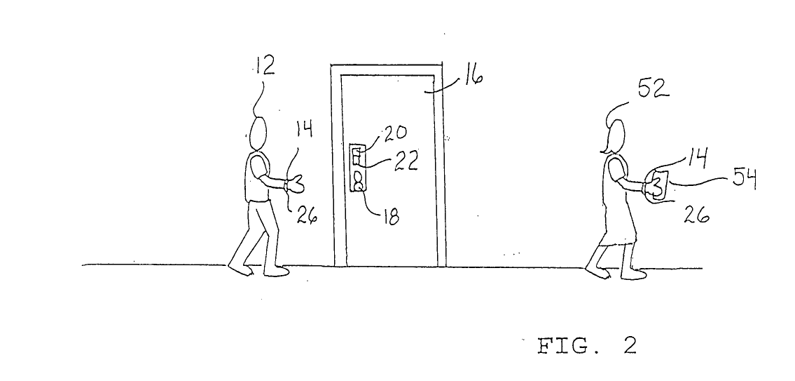

Referring to FIG. 1 there is illustrated a method of controlling movement on the inside and around the outside a facility generally referenced by numeral 10. Referring to FIG. 2, the method includes the step of providing each person 12 within facility 10 illustrated in FIG. 1, with a transmitter 14 which emits a unique personality profile. Embedded in the personality profile is an access level comprised of a set of rights and restrictions on the movement of that person 12 selected from multiple access levels.

Referring to FIG. 2, a further step includes providing each security door 16 with a lock 18, a receiver 20 and a controller 22. Receiver 20 receives the unique personality profile from transmitter 14. Controller 22 reviews the access level and unlocks lock 18 to security door 16 to permit access only when the unique personality profile has an appropriate access level.

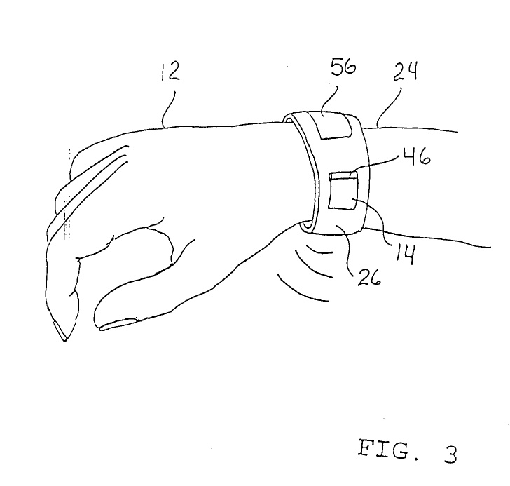

Referring to FIG. 3, in the illustrated embodiment, transmitter 14 is secured to a wrist 24 of person 12 with a tamper-resistant band 26. It will be appreciated, however, that there are other means for securing transmitter 14 to person 12. Referring to FIG. 2, controller 22 will initiate an alarm condition if tamper-resistant band 26 is removed. Controller 22 will also initiate an alarm when the unique personality profile of person 12 passing through security door 16 is not at the appropriate access level. Alarms can include audible cautions specific to the unique personality profile or the location of the person 12 within or outside facility 10 illustrated in FIG. 1. An example of an audible caution would be “move away from the door”. Alarms can also be activated when person 12 lingers too long near a door for which they do not have the appropriate access level.

Referring to FIG. 2, controller 22 can monitor a perimeter loop 28 illustrated in FIG. 1. Referring to FIG. 1, in the illustrated embodiment, perimeter loop 28 includes a wire as indicated by reference numeral 29 which is buried outside but in close proximity to facility 10. It will be appreciated that controller 22 could also monitor a loop which includes other features such as interior, ceiling, and perimeter of a facility 10. Controller 22 illustrated in FIG. 2 is then able to monitor the location of person 12 with perimeter loop 28 illustrated in FIG. 1. Alarms can be initiated which include audible cautions that are specific to the unique personality profile or the location of the person 12 on the loop 28. Referring to FIG. 1, in the illustrated embodiment, security doors 16 are present at an entry 30 to facility 10, and at various points through facility 10, including entry points 32 into rooms 34, exit points 36 from facility 10 to an enclosed outdoor area 38, and exit routes 40 from enclosed outside area 38.

Referring to FIG. 1, when the unique personality profile of person 42 is not at the appropriate access level, controller 22, illustrated in FIG. 2, permits such person 42 access when accompanied by another person 44 with a unique personality profile that is at the appropriate access level.

Referring to FIG. 1, security door 16 at exit point 36 from facility 12 to enclosed outdoor area 38 provides variable access which permits access to some access levels only when weather conditions are appropriate. Referring to FIG. 2, by way of example, controller 22 receives weather monitoring input and grants access to enclosed outdoor area 38 illustrated in FIG. 1, to persons 12 with such access levels only when the weather conditions are warm and sunny, but prohibits access when the weather conditions are rainy or cold. Weather conditions which are monitored can include humidity, temperature, and wind velocity. Weather conditions can also be monitored with respect to the time of day. When weather conditions change, an audible alarm can sound reminding person 12 to return indoors.

Referring to FIG. 2, persons 12 having the appropriate access level can now go in and out of security doors 16 with out the hassle of bypass keypunch pads or arming and disarming security doors 16 before and after entry and exit through them.

Referring to FIG. 3, transmitter 14 includes a global positioning module system 46 which remains dormant until activated by an alarm condition. Referring to FIG. 1, upon activation of an alarm condition such as when patient 48 enters room 50 or another area of facility 10 for which they do not have the appropriate access level, global positioning module system 46 illustrated in FIG. 3 allows for staff 52 to locate patient 48. This may be of particular assistance with facilities 10 which provide care to patients 48 with Alzheimer's disease or where patients 48 have the potential to become confused and wander outside of permitted areas of facility 10. Alarms are generated if patient 48 opens security door 16 that their personality profile does not grant access. Referring to FIG. 2, in most cases, security doors 16 will have locks 18 which automatically lock to eliminate this from happening. When alarms are generated, they are silently transmitted to quiet vibrating pocket pagers or wireless handheld telephone 54 carried by staff 52. Referring to FIG. 1, calls will be directed to staff 52 responsible or closest to room 50 or area of concern. Alarm can also be programmed to alert staff 52 to changes in outdoor weather conditions, so that staff 52 may ensure that patient 48 who are outdoors during poor weather conditions are located and returned to facility 10.

Referring to FIG. 3, additional features may be programmed into each individual wireless transmitter 14 that is secured to person 12 with a tamper-resistant band 26. Additional features include a panic button 56 that can be “programmed” so that person 12 has the ability to call to summon help wherever he or she is within facility 10 illustrated in FIG. 1. Transmitter 14 can be programmed for escalation signaling which sends a different signal in the event that the first series of summons or alarms have not been responded to in a predetermined time period. Referring to FIG. 2, voice enunciation can also be included in the features by means of a voice chip in controller 22. Referring to FIG. 3, furthermore, global positioning module system 46 allows for staff 52 illustrated in FIG. 1 to locate person 12 who has summoned for help. Referring to FIG. 3, the watertight construction of tamper-resistant band 26 allows for use in the bath or shower areas 58 illustrated in FIG. 1, which can be very slippery at times, resulting in accidents. Referring to FIG. 1, should an accident occur in the bath area 58 or any other area of facility 10, person 12 has the ability to summon help for themselves. Upon being summoned to help, staff 52 are able to quickly locate person 12.

Outline of Technical Operation

The Wander Protection System (WPS) is comprised of two components, the WMT—Wander Monitor Transmitter (Personality Bracelet) and the WMC—Wander Monitor Controller. WMT includes both a nurse call system and a proximity detector. The proximity detector is utilized in conjunction with a loop generator, and a series of loops and the WMC. When a WMT wearer approaches a loop, the wristband's proximity detector is excited and the WMT will emit an RF signal which will is recognized by our central controller.

The core of the WPS is the capability to program a profile into the WMT (up to 57,200 different profile combinations are supported). The controller is designed to react differently to different classes of profiles—programming of the controller is modified based in client requirements.

Where the WMT profile is set to emit an alarm when the proximity detector is activated, the WMT includes a ‘Re-set’ capability. The alarm states are reset when an authorized attendant (e.g. nurse in a healthcare facility) passes a magnet over the wristband. This serves two purposes, first it clears the alarm ensuring that multiple staff do not try and attend to a single event, and second, it provides a positive alarm response audit trail.

WMT—Wander Monitor Transmitter—Modes of Operation

Mode 1—Exciter 1

If enabled, exciter one is the main field activated when a bracelet comes up to a door. When the WMT comes within radius of this field the WMT will retransmit every 4 seconds.

1. OFF
2. ALZHEIMER—when WMT is detected by the door controller, the door will lock for “x” seconds, a voice message will repeat 2 times during lock condition . . . “please stand back from the door”, if ENV-1 is present, door will not lock, after door controller senses the WMT in the field for 8 seconds a message will encourage the WMT to exit into the courtyard and an input will be activated to excite an automatic door opener if used.
3. RESIDENT—functions the same as 2 unless ENV-2 is present on the WMC door controller by either a ENV smart input, or a program jumper.
4. STAFF—(Code+A) Staff Presence will simulate a reset/bypass at door controller allowing resident and Alzheimer bracelets to pass through with out setting off an alarm at the door controller. When this STAFF feature is selected the code (base+A) transmitted for exciter 1 must automatically be the same code transmitted from this WMT for Exciter 2. This will ensure the WMC door controller stays in the bypass override condition whether it is open or closed when a staff is present. This will allow staff to escort patients through monitored doors without tripping off the alarms. If the WMT is set in repeat & escalation modes the unique coding method that includes the panic (alarm bit) and (tamper-bit) in any message string will also allow the WMC door controller to make other decisions if the panic button or removal alarm were previously activated prior to entering into an exciter 1 or 2 fields.
   Mode 2—Exciter 2

If enabled, exciter two is activated at the door only when WMC door status shows an open condition. With the door in an open state, and the maglock unable to secure the door, the exciter two signal from the WMT will alert the door controller to an alarm condition, and at the same time the signal can be heard by Spider Alert if so programmed. If the WMT stays within an open door field exciter two, the WMT will transmit once then after 30 seconds, the WMT will transmit Exciter 2 (Base+6) every 4 seconds. When the WMC hears this signal every 4 seconds a message will sound at the door . . . “please move away from door”. (this will help to preserve on battery for residents loitering at an open door)

1. OFF

2. ONCE—sends signal out only once.

3. REPEAT—once activated, the delay between repeat alarms is set by (“x” time) in Mode 6. Mode 7 defines how many times the alarm will repeat (“x” cycles) and then stops unless reset. Mode 8—continuous, will override the number of cycles and will force the transmitter to continue to transmit according to the time delay interval set in mode 6 until reset.

Mode 3—Panic

If enabled, Panic is activated when the button is pushed on the WMT. Typically this featured is used for wireless nurse call and wireless staff-help. The repeat feature also allows for possible tracking of the WMT once activated. The Escalate allows for other alarm actions or notification to other response people if WMT is not reset.

1. OFF

2. ONCE—sends signal out only once

3. REPEAT—once activated, the delay between repeat alarms is set by (“x” time) in Mode 6. Mode 7 defines how many times the alarm will repeat (“x” cycles) and then stops unless reset. Mode 8—continuous, will override the number of cycles and will force the transmitter to continue to transmit according to the time delay interval set in mode 6 until reset.

4. ESCALATE—There are three panic alarm levels. The initial alarm (level 1), Escalation (level 2), and no-response (level 3). The delay between each Panic alarm transmission is defined under “X” time period and the amount of times each Panic Level transmits before it escalates to the next level is determined by “X” cycles. After level 3 is completed the transmitter automatically stops transmitting. Mode 8 can be set to allow for continuous rotation of Level 1,2,3, re-transmissions. Resetting with a magnet will stop all processes at any time

Mode 4—Tamper

When enabled, if the strap is removed, the WMT will transmit the bracelet removal alarm CODE. The WMT will send a restore signal once reconnected for 30 seconds. If set for Repeat, the WMT will re-transmit the same as Mode 2 & 3 repeat.

1. OFF

2. ONCE—sends signal out only once

5. REPEAT—once activated, the delay between repeat alarms is set by (“x” time) in Mode 6. Mode 7 defines how many times the alarm will repeat (“x” cycles) and then stops unless reset. Mode 8—continuous, will override the number of cycles and will force the transmitter to continue to transmit according to the time delay interval set in mode 6 until reset.

Mode 5—Supervisory

If enabled, the WMT will send out a supervisory status or test signal every hour. If low battery is selected, only a Low battery signal will be sent when the battery falls below an unsafe threshold.

1. OFF

2. Low Battery

3. ON—(Note: will reduce battery life)

Mode 6—Time

Time is the interval between auto alarm (repeat, escalation) transmissions.

1. 30 sec
2. 1 min.
3. 2 min.
4. 5 min
5. 10 min
   Mode 7—Cycle

(REPEAT)—Cycle defines the amount of times each alarm signal is transmitted or repeated before automatically stopping. (ESCALATION)—Cycle defines how many times each of the alarms in each of the levels transmits before escalating to the next level. MODE 6—Time sets the interval between each individual alarm transmission.

1. 2 cycles

2. 3 cycles

3. 4 cycles

4. 5 cycles

5. 6 cycles

Mode 8—Continuous

If selected (Repeat)—alarms continue to transmit until reset. (Escalate)—Level 1, 2, 3 will continue to cycle until reset. Note: activation of this feature will reduce battery life.

1. Yes

2. No

Mode 9—LED Blink

If selected LED will blink for visual notification that the WMT is in a repeat or escalation mode. Magnetic reset, will cancel blink. Note: activation of this feature will reduce battery life.

1. Yes

2. No

Programming the WMT

PROGRAMMING: to enter program mode, apply jumper on back of circuit board. LED will flash long flashes to match the mode and short flashes to indicate program choice within each mode. To move along to other modes hold button in for the count of 3 then release, continue this process until you reach your desired mode. You do not have to wait for LED blinks to move through modes. Once you are at the mode you want to program, press the button for the count of 1 and release to set the desired program for each mode. The number of short blinks matches the program selection.

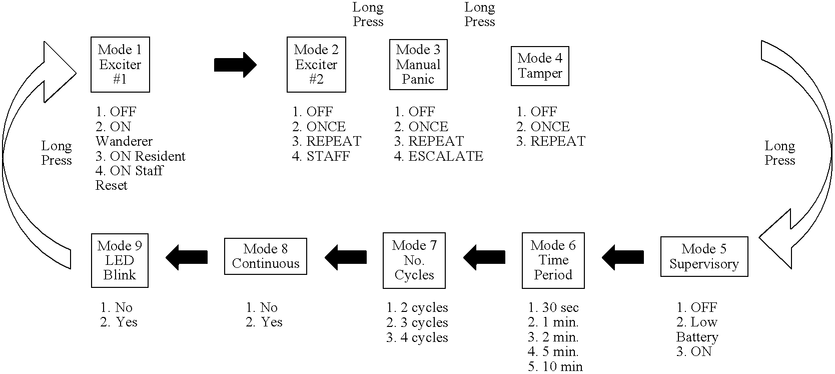

WMC Controller

The WMC Controller is an integral part of the Wander Monitor system. The WMC acts as the intelligent link between the WMT personality bracelets and the central security system facilitating the transition from controller based security used to restrict movement and generate alarms to a new paradigm where the personality bracelet acts as the controller to enhance patient care and improve staff efficiency.

The WMC comes pre-programmed to respond appropriately to the various personality profiles available in the WMT personality bracelets. The settings described on the following pages may be used to customize the WMC's response based on the user environment, patient mix and requirements.

2. Specification

Number of Inputs: 6 open or closed collectors

Number of Outputs: 6, open or closed collector type, 100 mA max. sinking current

Number of Relays: one form C relay 1 amp at 12 vdc

Unit ID number: 8-bit code (2 hexadecimal digits)

Communication Protocol: SpiderAlert 1A

Attendance Report Repetition Rate: once every 90 seconds.

Input Voltage: 10-16 VDC.

Input Voltage: 10-16 VDC.

Current Drain: Approximately 7 mA standby, 13 mA maximum.

Operating Temperature Range: −10° C. to 49° C. (14° F. to 120° F.)

Dimensions (H×W×D): 108×165×38 mm (4¼×6½×1½ in.)

Weight: 191 g (6.75 oz)-300 g

3. Inputs, Outputs and Reporting Modes

3.1a Input Circuits

Six input circuits of open collector type are available for reporting events to the WMC for decision-making.
INPUT 1—ENV 1 condition=output 1 activation
INPUT 2—ENV 2 condition=output 2 activation
INPUT 3—door status (normal condition closed)
INPUT 4—remote reset/by bypass, with time delay 2 position dip switch setting 5,6
INPUT 5—RTE-request to enter, opens relay (lock), but alarm may still sound if WMT is in the field. Activates the lock according to 2 position dip 5,6
INPUT 6—Active mode trigger; this input is normally used when installing WMC's within close proximity of one another. If this input is normally open the WMC continually monitors the WMT codes. If this input is normally closed the WMC does not transmit alarms for the WMT's. An opening of the loop causes the WMC to respond to alarms from the WMT's, it will continue to do so according to the time setting selectable by 2-position dipswitch setting 7,8. Each pulsed opening will reset the timer.
   3.1b Dip Switch and Settings
1 on—puts WMC in record message mode
2 on—enables RED button for WMC reset
3 on—spider mode
4 on—spider mode (future)
5 reset/bypass time delay, 10, 20, 40, 80 seconds
6 reset/bypass time delay, 10, 20, 40, 80 seconds
7 sleep mode settings, 30, 60, 120, 240 seconds
8 sleep mode settings, 30, 60, 120, 240 seconds
   3.1c LED's

The WMC's red LEDs illuminate while it is engaged in message transfer, until an acknowledgement is received. The green LED is always on indicating power is ok. The green LED will turn and flash yellow until the SR500 is connected or spider bus connection when dip 3 is on. The green LED will turn solid yellow for 3 seconds when the WMC hears any of the WMT signal with low battery and/or tamper. (Voice message tamper/low bat will also sound for one duration) The red LED will flash as the message is sent to Spider head end.

3.2a Output Circuits

The WMC provides Six output terminals and one Form C relay rated @ 2 amp-30 VDC. The output circuits, which are of the open-collector type, are under control of the WMC firmware—they can be activated (pulled LOW), automatically by WMC command. Each output may be used to sound an alarm by interfacing to a remote security monitoring system, to control devices, to open a door controlled by an electrical door strike, or for many other tasks. Since each output cannot sink more than 100 mA, an interface relay might be required for controlling external devices. Output 1 latches until reset. All other outputs pulse for 3 seconds upon detection of condition from any of the WMT codes.
OUTPUT 1—alarm exciter 1, upon detection of Level 1&2 WMT only if input 3 is open. Alarm message 2 will sound every 5 seconds until reset.
OUTPUT 2—alarm exciter 2
OUTPUT 3—WMT panic button, this output will pulse when the WMC hear any of the WMT's panic codes base +2, +3, +4.
OUTPUT 4—WMT bracelet Low Bat.
OUTPUT 5—WMT bracelet tamper
OUTPUT 6—Auto door opener control; activates only when ENV2 pulse condition is present.
   Relay form C—control electric locking device upon detection of WMT level 1 & 2 in field.
   3.2b Speaker Messages

WMC has a built in speaker and mic for programming in 6 personal alarm messages for the purpose of commands to the resident at the door and sounding alarms in the event of a breach. These are the default messages.

MESSAGE 1—“chime” “please stand back from the door” every 5 seconds.

MESSAGE 2—fast “chime, chime” “door alarm” every 3 seconds

MESSAGE 3—“chime” “please stand by”

MESSAGE 4—“chime” “access granted please exit now”

MESSAGE 5—“chime” “access denied”

MESSAGE 6—“chime” “door bypass” . . . Every 10 seconds while staff bracelet is in field. (red light blink in bypass mode)

To program custom messages, put dipswitch 1 into the on position. Red light will blink once every second. By pressing the tamper button you can escalate to the next message and so on. Hold in the RED button for 3 seconds when green light blinks start recording, let off red button when done green light goes back to solid. Still in record mode, to play back recorded message press red button once quickly. To program or play next message press tamper button once to move forward. Turn dip 1 off when complete. Red LED will go out and green will go solid. To reset the messages back to the default, hold the tamper and red button in at the same time for 3 seconds.

3.3 Tamper Event Reporting

A normally closed tamper switch protects the WMC against tampering. Once the cover is removed a tamper alert is sent to the head-end computer

3.4 Reporting Modes

The WMT personality bracelets are viewed by the WMC on 3 different levels.

Level 1—Base+8: “Wanderer”

Once this signal is received the WMC will activate the form c relay to lock the door and sound message 1 across the speaker every 5 seconds. If input 1 is open message 2 will lock in and repeat every 3 seconds and output 1 will activate until a valid reset input 2 toggle, red button toggle (if activated), or Level 3 presence is received.

If ENV 1 input is activated, the WMC will receive the Base+8, sound message 3, and send (Base+status) to the control computer, the controller will then check to see if this code is approved to exit, if it is, the bracelet wearer will have time according to dip 5,6 to pass through the door without triggering an alarm. The WMC will also pulse output 6 for 3 seconds. This can be used to trigger an automatic door opener. In stand alone mode. ENV 1 input will allow Level 1 WMT wearer to exit without alarm.

Level 2—Base+9: “Resident”

Once this signal is received the WMC will activate the form C relay to lock the door and sound a message 1 across the speaker every 5 seconds. If input 1 is open message 2 will lock in and repeat every 5 seconds and output 1 will activate until a valid reset input 2 toggle, red button toggle, or Level 3 presence is received.

If ENV 1 input is activated, the WMC will allow a (Base+9 resident bracelet) through the door with out any alarms or auto locking.

Level 3—Base+A: “Staff”

When this bracelet enters into the field detection loop at a WMC door the WMC will automatically sense that a staff is in the vicinity and the WMC if in alarm will reset and bypass for 10 seconds. If the staff stays within the field at the WMC, the WMC will stay in a bypass mode until the staff bracelet leaves the vicinity. Bypass message will sound every 10 seconds.

5. Installation

5.1 Mounting

The WMC is supplied in a UPB-1 plastic cabinet. To install the UPB-1 cabinet, proceed as follows:
   A. Remove the screw securing the UPB-1 cover to the base.
   B. Insert a small screwdriver blade into the slot near one of the snap-in teeth, as shown. Carefully flex the cover edge out, until the tooth disengages the dent. Repeat this with the other tooth to free the cover edge completely.
   C. Swing the free edge of the cover diagonally up and move it slightly backwards to disengage the tabs at the back.
   D. Hold the base against the mounting surface and mark the points for drilling, which become the mounting holes.
   E. Drill the mounting holes and insert wall anchors if necessary. Bring the wires into the base through the wiring holes or wiring knockouts. Attach the base to the mounting surface with two long screws.
   F. Complete the wiring as described in Sections 5.2-5.4.
   5.2 Connection to the Visonic SpiderAlert Bus

The WMC may be connected to the SpiderAlert bus via the telephone type bus port, which is a 4-position RJ-11 receptacle. If you prefer the quick attach/detach feature of telephone-type connectors, you will need a 4-pin RJ-11 mating plug that is commonly called “TELCO plug”

If an RJ-11 (TELCO) plug is used for connecting the WMC-SR500 to the SpiderAlert bus, the following items would be required:

An unspecified length of 4-lead, color-coded modular cable for producing a patch cord connecting the WMC-SR500 BUS port to the bus junction box.
Two 4-position RJ-11 plugs, to terminate both ends of the patch cord.
A crimping tool for RJ-11 plugs.
   To complete the connection to the bus, proceed as follows:
A. Identify the 4 wires of each bus and connect them to the numbered terminals within the junction box, maintaining the order required for correct patching.
B. Prepare an RJ-11 to RJ-11 patch cord, long enough to bridge the distance from the bus receptacle of the WMC-SR500 to the junction box. Make sure a “one-for-one” configuration is obtained, where pin 2 is connected to pin 2, pin 3 to pin 3, etc.
   CAUTION: Do not use a ready-made TELCO RJ-11 to RJ-11 patch cord, because it very rarely has the above mentioned “one for one” design.
   5.3 Input Loop Wiring

If you wish to report up to 6 kinds of local alarms to the head-end computer, connect normally closed (N.C.) sensor contacts across the alarm inputs and the ground (−) terminal.

5.4 Output Circuit Wiring

LEDs or buzzers connected to the output terminals will light or beep, respectively, by manually entered or automatic command received from the head-end computer. Relays connected to the output terminals will pull in and drop out by similar commands. The relay contacts may be wired to open or close doors, to control lighting fixtures, sound an alarm, switch wireless transmitters or CCTV on and off, etc.

Either output terminal is suitable for operating a low-current 12 VDC buzzer, an LED, or an auxiliary relay that draws less than 100 mA current. In case of a relay, connect its operating coil across the OUT1 and 12 V(+) or OUT2 and 12 V(+) terminals.

Relays connected to OUT1-OUT6 will pull in by manually entered or automatic command received from the head end computer. Relay contacts may be wired to open or close doors, to control lighting fixtures, to sound an alarm, to switch a wireless transmitters or CCTV on and off, etc.

Additional features include the following:

replaceable batteries
low battery detection with a audible or silent alarm
repeat feature on panic button
panic button inhibitor to avoid unnecessary calls
test feature to ensure proper working order
magnetic reset
   The method described above can also used for the following:
Wandering patient monitoring and automatic door locking
Automatic door proximity control
Infant monitoring containment
Infant removal detection
Tracking on alarm condition
Staff, guard, and resident panic alert
Automatic door entry and opening upon proximity
   The following benefits result from use of the above described method:
requires less staff to handle more residents
limits noise or disturbance to the quiet environment
Enhances freedom of movement for staff and patients
Economical retrofits to existing systems
improved quality of life
longer home time when used in conjunctions with elder homecare services

While the method has been described above in relation to care facilities directed toward patients with Alzheimer's disease, it will be appreciated that other types of facilities such as, prisons, companies with security concerns or elder homecare service could also use the above described method.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

1. A method of controlling movement on the inside and around the outside of a facility, comprising the steps of:
providing each person within the facility with a transmitter which emits a unique personality profile, embedded in the unique personality profile is an access level for that person selected from multiple access levels;
providing each security door with a lock, a receiver and a controller, the receiver receiving the unique access personality profile from the transmitter, the controller reviewing the access level and unlocking the lock to the security door to permit access only when the unique personality profile has an appropriate access level.

2. The method as defined in claim 1, the transmitter being secured to the person with a tamper-resistant band.

3. The method as defined in claim 2, the controller initiating an alarm condition when the tamper-resistant band is removed.

4. The method as defined in claim 1, the controller initiating an alarm when the unique personality profile of a person passing through the security door is not at the appropriate access level.

5. The method as defined in claim 1, the controller monitoring a perimeter loop, which includes at least one of the security doors.

6. The method as defined in claim 1, when the unique personality profile of the person is not at the appropriate access level, the controller permitting such person access when accompanied by an accompanying person with a unique personality profile that is at the appropriate access level.

7. The method as defined in claim 1, when there are some variable access security doors which are accessible to some access levels only when weather conditions are appropriate, the controller receiving weather monitoring input and granting access to persons with such access levels only when weather conditions are appropriate.

8. The method as defined in claim 4, the transmitter including a global positioning module system which remains dormant until activated by an alarm condition.
